(19) United States
(12) Patent Application Publication
(10) Pub. No.: US 2016/0190841 A1
(43) Pub. Date: Jun. 30, 2016

(54) PRECHARGING UNIT FOR A BATTERY INTERRUPTION UNIT

(71) Applicant: ROBERT BOSCH GMBH, Stuttgart (DE)

(72) Inventor: Gergely Galamb, Traunstein (DE)

(21) Appl. No.: 14/910,912

(22) PCT Filed: Aug. 1, 2014
(86) PCT No.: PCT/EP2014/066572

§ 371 Date: Feb. 8, 2016

(30) Foreign Application Priority Data
Aug. 7, 2013 (DE) 10 2013 215 563.8

(51) Int. Cl. H02J 7/00

(52) U.S. Cl. CPC H02J 7/0045; H02J 7/0031

(57) ABSTRACT

A battery interruption unit and a precharging unit, comprising a main contactor, a precharging contactor, a precharging resistor and a housing, are proposed. The main contactor and the precharging contactor, in the same way as the precharging resistor, are arranged in the housing. The precharging resistor and the precharging contactor are electrically connected, as an electrical series circuit in parallel with the main contactor, to two external electrical connections on the housing.

### BACKGROUND OF THE INVENTION

The present invention relates to a precharging unit for a battery disconnect unit. In particular, the present invention relates to a precharging unit as a functional unit, combined in a separate housing, for use in battery disconnect units of different designs.

US 2011/133701 A1 and U.S. Pat. No. 6,034,504 A each disclose a battery charging device with a built-in protection apparatus. The battery charging device permits two different operating modes for charging the battery at different speeds.

When high voltage (HV) traction batteries are used in hybrid vehicles and electric vehicles, electromechanical components for connecting the high voltage (HV) connections (referred to as “contactors”), fuses, current sensors, precharging resistor and precharging contactor are frequently combined in one component, referred to as a battery disconnect unit (BDU). As a result of the fact that the installation spaces differ greatly from one vehicle model to another, it is usually not possible always to install identical battery disconnect units. It is therefore not possible to standardize a battery disconnect unit, and vehicle-model-specific development expenditure is incurred anew (with virtually every type of vehicle). The individual components of the battery disconnect unit are arranged in different housings on a customer-specific basis depending on the design of the housing even though the same components are used in many batteries. In this way, development and tooling costs are incurred for each new design of a battery disconnect unit, and said costs are spread over only a small production quantity.

### SUMMARY OF THE INVENTION

The invention basically describes a possible way of being able to group the precharging unit including the main contactor within a battery disconnect unit and to use said precharging unit as a standard component for different designs of a battery disconnect unit. A precharging unit according to the invention comprises in this context a main contactor, a precharging contactor and a precharging resistor which are accommodated in a common housing. The precharging contactor is configured, in conjunction with the precharging resistor, to charge an intermediate circuit capacitor with a maximum current limited by the precharging resistor, when an electrochemical energy accumulator is connected to an on-board power supply system (for example of a means of locomotion). The main contactor, which does not have a precharging resistor, is only closed subsequently. However, owing to the precharged intermediate circuit capacitor the voltage difference between the energy accumulator and the intermediate circuit capacitor is no longer so high that undesirably high equalizing currents flow. According to the invention, the precharging resistor and the precharging contactor are electrically connected, as an electrical series circuit in parallel with the main contactor, to two external electrical connections on the housing of the precharging unit according to the invention. In other words, the housing has at least two external electrical connections which each make the main contactor or the series circuit composed of the precharging resistor and the precharging contactor electrically contactable. The arrangement proposed above has the advantage that the entire precharging unit can be constructed in the same way in a multiplicity of different battery disconnect units. The precharging unit according to the invention can therefore be fabricated cost-effectively in large production numbers. In addition, all the components are already connected to one another in the unit, with the result that only the positive and the negative high voltage (HV) connections have to be connected from the outside. The entire unit requires only a minimum number of attachment points, as a result of which the design of the entire battery disconnect unit is simplified. The precharging unit according to the present invention can be arranged differently in any battery disconnect unit, as a result of which a maximum degree of flexibility in order to correspond to a multiplicity of different configurations of the battery disconnect unit becomes possible. In addition, the housing offers the possibility of acoustic encapsulation of the contactors which switch relatively noisily. Furthermore, solid-borne sound isolation can be implemented easily and cost-effectively owing to the small number of mechanical interfaces with the peripherals. Furthermore, mutually influencing functions of the units which are contained can be taken into account a priori by virtue of the spatial combination. For example, a specific predefined relative orientation of the main contactor with respect to the precharging contactor can be predefined in an advantageous manner.

The housing is advantageously fabricated from plastic and/or from metal. While fabrication from metal permits particularly good conduction of heat away from the precharging unit, the use of plastics makes simple electrical insulation and cost-effective fabrication possible.

The precharging resistor is also preferably coupled to a metallic part of the housing with good thermal conductivity. In other words, the precharging resistor is arranged spatially close to the metallic part of the housing and/or is coupled thermally thereto by means of thermal conducting medium (for example a thermally conductive paste). In this way, overheating of the precharging resistor when an intermediate circuit capacitor of an on-board power supply system is being precharged can be prevented.

The main contactor and the precharging contactor are also preferably arranged essentially identically in terms of their opening directions. In other words, a part which is moved when the respective contactor opens or closes moves in the same direction. This provides the advantage that in the event of an external impact on the precharging unit according to the invention or in the event of extreme acceleration of the precharging unit according to the invention, (undesired) closing of both contactors as a result of the inertia of their components can be brought about essentially only in one direction. In contrast, an impact which acts in the opposite direction does not bring about an undesired closing process either for the main contactor or for the precharging contactor.

An alternative arrangement is that the main contactor and the precharging contactor are arranged essentially oriented in opposition to one another in terms of their opening directions (that is to say direction of movement during opening). In this way, in the event of an external shock in the opening or closing direction in each case one contactor will preferably close, while the other will preferably open. It is therefore possible to ensure that in the event of an external shock there is a high probability that at least one of the two contactors remains open or is opened.

For example, the precharging resistor has an electrical resistance <100Ω. For example, the precharging resistor can preferably be dimensioned between 20 and 60Ω, preferably between 30 and 50Ω. The specified resistance range is typical for a precharging resistor such as is used for precharging an intermediate circuit which is present in an electrically operated vehicle (EV, HEV).

The precharging unit according to the invention with further preference also comprises a solid-borne sound isolating unit by means of which it is configured to be secured to a peripheral. In other words, the solid-borne sound isolating unit can reduce the operating noise of the relatively noisy contactors to the effect that the sound signals are only passed on in a damped fashion to the surrounding fixed structure. An example of solid-borne sound isolating units is elastic sections which have a low-pass characteristic. In this way, the pulse-like excitations of the operating noise of the contactors can be considerably isolated.

The housing is also preferably configured to be used as a closure of a control device (for example a battery disconnect unit which functions as a peripheral of the precharging unit according to the invention) which is assigned to the precharging unit. In other words, a housing of the assigned control device can have an opening which is closed off by the housing of the precharging unit when the precharging unit according to the invention is assembled. In this way, housing sections of the precharging unit can also be used to close off an encapsulation of the assigned control device.

The external electrical connections of the precharging unit according to the invention are also preferably configured to be arranged within a volume which is closed off by the housing of the precharging unit and by the housing of the assigned control device. In other words, the external connections are arranged on the housing of the precharging unit in such a way that electrical contact can be made therewith by its peripherals, while the housing of the precharging unit houses, in conjunction with the housing of the assigned control device, the corresponding electrical connections. In this way, external wiring is eliminated and the electrical connection is protected from external influences (for example in a fluid-tight fashion).

According to a further aspect, a battery disconnect unit comprising a precharging unit is proposed such as has been described in detail above in conjunction with the first-mentioned aspect of the invention. The battery disconnect unit (BDU) can satisfy here even different, customer-specific geometric and electrical boundary conditions, while its interface with the precharging unit according to the invention is of essentially identical design in each case, wherein the abovementioned advantages are obtained.

### BRIEF DESCRIPTION OF THE DRAWINGS

Exemplary embodiments of the invention are described in detail below with reference to the accompanying drawings, in which:

FIG. 1 shows a schematic illustration of a typical BDU for hybrid vehicles without a fast charging function;

FIG. 2 shows a schematic illustration of a typical BDU for hybrid vehicles with a fast charging function and additional secondary assemblies; and

FIG. 3 shows a schematic illustration of an exemplary embodiment of a precharging unit according to the invention.

### DETAILED DESCRIPTION

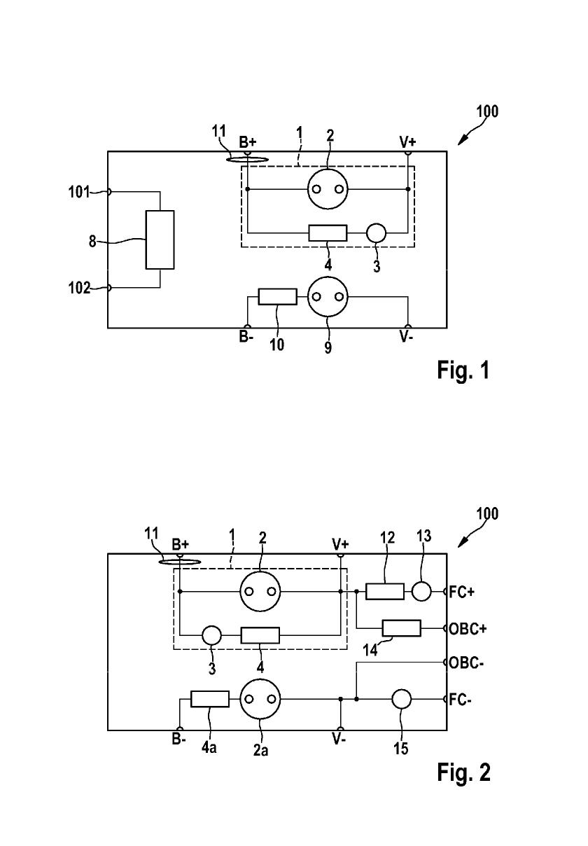

FIG. 1 is a schematic view of an inventive battery disconnect unit 100 comprising a precharging unit 1 according to the invention. The precharging unit 1 according to the invention is highlighted functionally in the battery disconnect unit 100 according to the invention by a dashed demarcation line. The precharging unit 1 comprises a main contactor 2, a precharging contactor 3 and a precharging resistor 4 which is connected in series with the precharging contactor 3. The abovementioned two-terminal networks are electrically connected to connections B+, V+ which are arranged externally on the housing of the battery disconnect unit 100. A current sensor 11 is configured to measure a current through the external connection B+. Two external connections B−, V− are arranged opposite the external connections B(Body)+, V(Vehicle)+and are electrically connected by a second main contactor 9 to a fuse 10, in series with the latter, within the housing of the battery disconnect unit 100 according to the invention. A second fuse 8 which is also arranged within the battery disconnect unit 100 can be connected electrically to a peripheral of the battery disconnect unit 100 via two additional external contacts 101, 102.

FIG. 2 shows an alternative exemplary embodiment of a battery disconnect unit 100 according to the invention as a schematic circuit diagram. The external electrical connections B+, V+, B−, V− and the elements which connect them correspond to the arrangement illustrated in FIG. 1. In order to implement a fast charging function, the battery disconnect unit 100 illustrated in FIG. 2 has four additional external connections which are denoted by FC+, OBC+, OBC−, FC−. The connections FC+ and OBC+ are electrically connected to the connection V+ via a series connection of a second contactor 13 to an ohmic resistor 12 or exclusively an ohmic resistor 14. The external connection OBC− is electrically short-circuited to the connection C−, while a third contactor 15 is arranged between the external connection FC− and the connection V−. Vehicles with a separate connection for a fast charging pillar (fast charge connection, FC) usually have separate contactors via which the connecting terminals 13 and 15 can be connected at zero potential. This circuit can, as illustrated, be additionally protected by means of a fuse 12. In addition, connections for an onboard charger (OBC) or air-conditioning system compressors are present on the BDU and are also protected by means of a fuse 14 according to the prior art.

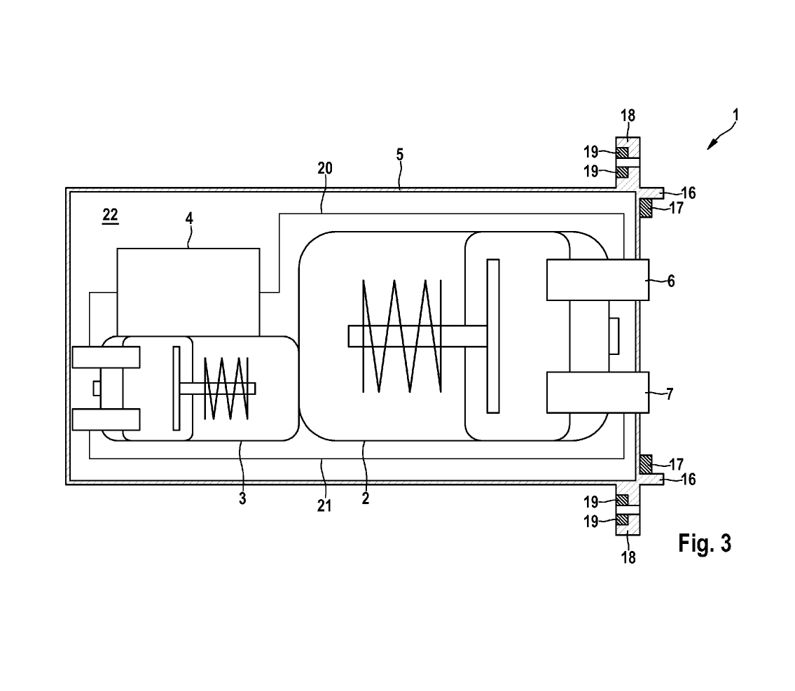

FIG. 3 shows a view of a detail of a schematically illustrated exemplary embodiment of a precharging unit 1 according to the present invention. Two electrical connections 6, 7 project out of a housing 5. Both are configured to be electrically connected to each other via a main contactor, which closes in the direction of the connections 6, 7, or a series circuit composed of a precharging resistor 4 and a precharging contactor 3, which opens in the direction of the connections 6, 7. The main contactor 2 and the precharging contactor 3 are arranged “back-to-back” with respect to one another, with the result that the smaller volume of the precharging contactor 3 permits the precharging resistor 4 to be arranged next to the precharging contactor 3. The narrow side on which the external connections 6, 7 project out of the housing is surrounded by a collar 16. A rubber lip 17 as a solid-borne sound isolating unit is arranged inside the collar 16, said solid-borne sound isolating unit being able to absorb a prestress between the housing 5 of the illustrated precharging unit 1 and its peripherals. In addition, a flange 18 for screwing the precharging unit 1 to its peripherals is additionally provided outside the collar 16. The flange 18 also has rubber elements 19 for solid-borne sound isolation. Said rubber elements 19 are configured to absorb a prestress which is generated between the flange 18 and a screw head (not illustrated). The housing 5 is additionally filled with a thermal conducting medium 22 which serves to heat the precharging resistor 4 and the contactors 2, 3. A further function of the thermal conducting medium 22 is to embed the electrical leads 20, 21 between the external connections 6, 7 and the precharging contactor 3 or the precharging resistor 4 and between the precharging contactor 3 and the precharging resistor 4, and therefore protect them against mechanical impacts. In addition, the thermal conducting medium 22 assumes the function of solid-borne sound insulation with respect to the operating noise of the contactors 2, 3. The unit composed of the precharging contactor 3 and precharging resistor 4 is also frequently referred to as a precharging circuit. In other words, the precharging unit according to the invention can be described as or conceived as being a housing unit comprising a precharging circuit together with a main contactor.

Even if the aspects according to the invention and advantageous embodiments have been described in detail with reference to the exemplary embodiments explained in conjunction with the appended figures in the drawings, modifications and combinations of features of the illustrated exemplary embodiments are possible for a person skilled in the art without departing from the scope of the present invention, the scope of protection of which is defined by the appended claims.

1. A precharging unit (1) for a battery disconnect unit (100), comprising
a main contactor (2),
a precharging contactor (3),
a precharging resistor (4), and
a housing (5), wherein the main contactor (2), the precharging contactor (3) and the precharging resistor (4) are arranged in the housing (5), wherein in addition
the precharging resistor (4) and the precharging contactor (3) are electrically connected, as an electrical series circuit in parallel with the main contactor (2), to two external electrical connections (6,7) on the housing (5).

2. The precharging unit as claimed in claim 1, wherein the housing (5) comprises plastic and/or metal.

3. The precharging unit as claimed in claim 1, wherein the precharging resistor (4) is thermally coupled to a metallic part of the housing (5) by means of a thermally conductive paste.

4. The precharging unit as claimed in claim 1, wherein the main contactor (2) and the precharging contactor (3) are arranged essentially identically oriented in terms of their opening directions.

5. The precharging unit as claimed in claim 1, wherein the main contactor (2) and the precharging contactor (3) are arranged essentially oriented in opposition to one another in terms of their opening directions.

6. The precharging unit as claimed in claim 1, wherein the precharging resistor (4) has a resistance of less than 500 ohms.

7. The precharging unit as claimed in claim 1, wherein the precharging unit (1) also comprises a solid-borne sound isolating unit (17, 19), by means of which it is configured to be secured to a peripheral.

8. The precharging unit as claimed in claim 1, wherein the housing (5) is configured to be used as a closure of a control device (100), assigned to the precharging unit, as a peripheral.

9. The precharging unit as claimed in claim 8, wherein, in particular, the external electrical connections (6, 7) are configured to be arranged within a volume, closed off by the housing (5), of the assigned control device (100).

10. A battery disconnect unit (100), comprising a precharging unit (1) as claimed in claim 1.

11. The precharging unit as claimed in claim 1, wherein the precharging resistor (4) has a resistance of between 20 and 60 ohms.

12. The precharging unit as claimed in claim 1, wherein the precharging resistor (4) has a resistance of between 30 and 50 ohms.
